(19) United States
(12) Patent Application Publication
(10) Pub. No.: US 2009/0271383 A1
(43) Pub. Date: Oct. 29, 2009

(54) METHOD FOR DERIVING CONTEXT FOR DATA DISCLOSURE ENFORCEMENT

(75) Inventors: Anuradha Bhamidipaty, Bangalore (IN); Tyrone Grandison, San Jose, CA (US); Ajay Kumar Gupta, New Delhi (IN)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 12/107,862

(22) Filed: Apr. 23, 2008

(51) Int. Cl. G06F 17/30

(52) U.S. Cl. 707/4; 707/E17.062

(57) ABSTRACT

Techniques for deriving a context for enforcing a data disclosure policy while accessing a database are provided. The techniques include receiving a request for database access with met a information, parsing the meta information to identify a context, receiving a user query, formulating a query equivalent to-the user query, wherein the equivalent query implements the identified context to enforce a data disclosure policy, and accessing the database with the equivalent query.

### FIELD OF THE INVENTION

The present invention generally relates to information technology, and, more particularly, to data disclosure policy enforcement.

### BACKGROUND OF THE INVENTION

Changing existing infrastructure is not a feasible option for enterprises. However, enterprises may need to make their systems compliant with security and privacy requirements from their clients and from legislative bodies. In order to do this and minimize the impact on their system, a mechanism for enabling the exact context under which a query or request is being made by a user needs to be determined. Many, however, have ignored this problem, which has led many to think that making their systems compliant with minimal impact is not possible.

As such, existing approaches do not enforce a security policy while accessing a database by determining a context from a query tagged with context information. Also, existing approaches, for example, describe extending relational databases to allow fine grained access control either by extending language constructs or by specifying security policies as stored procedures. Such approaches, however, do not articulate the mechanism(s) used to get the contextual information from the application layer, but merely assume the problem to be solved.

### SUMMARY OF THE INVENTION

Principles of the present invention provide techniques for deriving context for data disclosure enforcement. An exemplary method (which may be computer-implemented) for deriving a context for enforcing a data disclosure policy while accessing a database, according to one aspect of the invention, can include steps of receiving a request for database access with meta information, parsing the meta information to identify a context, receiving a user query, formulating a query equivalent to the user query, wherein the equivalent query implements the identified context to enforce a data disclosure policy, and accessing the database with the equivalent query.

At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating exemplary system architecture, according to an embodiment of the present invention;

FIG. 2 is a diagram illustrating a disclosure control system with context derivation component, according to an embodiment of the present invention;

FIG. 3 is a diagram illustrating query execution flow, according to an embodiment of the present invention;

FIG. 4 is a flow diagram illustrating techniques for deriving a context for enforcing a data disclosure policy while accessing a database, according to an embodiment of the present invention; and

FIG. 5 is a system diagram of an exemplary computer system on which at least one embodiment of the present invention can be implemented.

### DETAILED DESCRIPTION OF PREFERRED EMBODIMENTS

Principles of the present invention include defining a mechanism that allows a user to specify meta-information with an access request, and therefore derive the context that can be used by a database to enforce the relevant access control restrictions and/or policies. Also, principles of the invention include techniques for enforcing security and privacy policies while accessing a database, in which a database query with meta-data is received from a user, the meta-data is parsed to identify a context (for example, application environment) of the database query, and an equivalent policy-compliant query is generated and used to access the database.

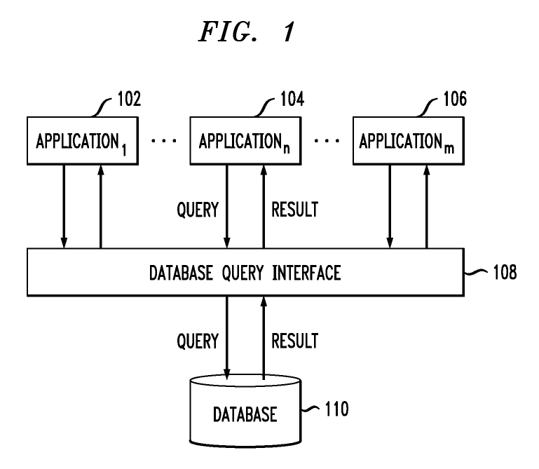

Enterprises have significant investment in their existing infrastructure, which are normally built to accomplish their core functions and the subsidiary operations that arose from these functions. Data disclosure controls (that is, security and privacy technology), have been treated as an after-thought for such systems. However, customer concerns and legislative pressure are requiring that enterprises provide (native) controls that protect the information in their repositories. As depicted in FIG. 1, the systems used in many existing approaches leverage an architecture where applications access data sources through a programmatic interface.

FIG. 1 is a diagram illustrating exemplary system architecture, according to an embodiment of the present invention. By way of illustration, FIG. 1 depicts the elements of application₁ 102, applicationₙ 104, applicationₘ 106, database query interface 108 and database 110.

In one or more embodiments of the present invention, disclosure controls can be placed either at the data source or the interface level, thereby lessening the window of exposure for sensitive information and allowing flexibility, scalability and simplicity in the design and implementations of the database applications. The techniques described herein integrating security and privacy technology advocate placing the disclosure control at the interface level, where it is advantageous to determine which policy rules should be applied to each request issued. The rules relevant to a particular request can be determined by the system evaluating the context of the situation, wherein context refers to parameters that embody information about the application environment of the request.

However, a major concern for enterprises is the impact of new technology on their production systems. Constraints of new technology can include, for example, that it should have minimal (or no) impact on the performance and storage requirements of the core system(s) and not require (significant) modification to the systems. Therefore, in transforming non-compliant systems into their security and privacy-compliant equivalents, it is desirable to pass context information to a disclosure control system automatically without user intervention (that is, without impacting the enterprise's workflow).

As such, one or more embodiments of the present invention derive context information automatically based on meta information sent by an application. Also, the techniques described herein outline an example scenario using an augmented Hippocratic Database (HDB) Java database connectivity (JDBC) interface.

A privacy policy can include various elements such as, for example, accessor, purpose, recipient, data, etc. Privacy policies can be stored in the disclosure metadata system and used to enforce the privacy constraints and obligations consistent with an enterprise's and clients' requirements. Enforcement of policy is possible when the system can use the context to determine the applicable rules. Context can include, for example, purpose, accessor, application name or some other environmental information.

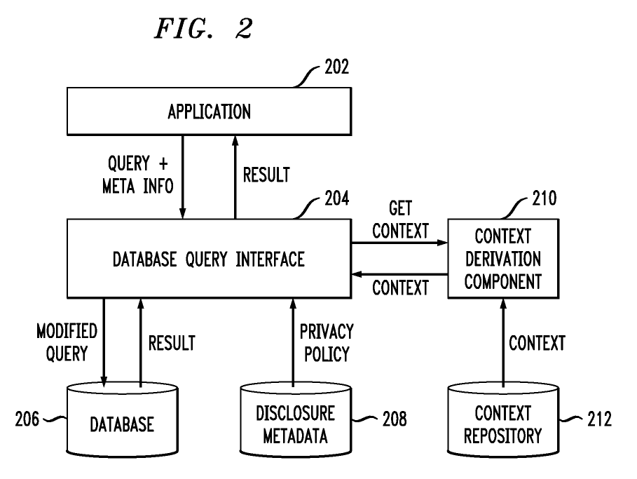

FIG. 2 is a diagram illustrating a disclosure control system with context derivation component, according to an embodiment of the present invention. By way of illustration, FIG. 2 depicts the elements of an application 202, a database query interface 204, a database 206, disclosure metadata 208, a context derivation component 210 and a context repository 212.

FIG. 2 illustrates the system architecture where context has been derived automatically using a context derivation component. Initially, an application can issue an SQL query to the privacy-enabled system. It can also send meta information along with the query such as, for example, connection pool and application identification (ID). The meta information can include any application environment information. Context information is stored in a context repository, which could be on a file system, in a relational database, or any other storage system. The context derivation component is responsible for retrieving the context from the underlying repository based on meta information. Using the context, the query interface retrieves the relevant privacy policy rules, modifies the request, executes it and returns the results to the application.

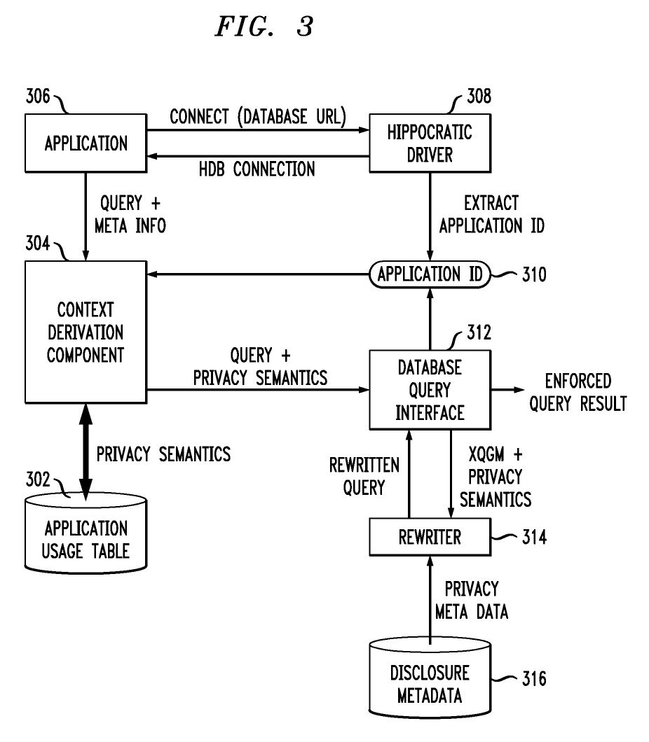

FIG. 3 is a diagram illustrating query execution flow, according to an embodiment of the present invention. By way of illustration, FIG. 3 depicts the elements of an application usage table 302, a context derivation component 304, an application 306, Hippocratic driver 308, application ID 310, database query interface 312, rewriter 314 and disclosure metadata 316.

As described herein, an exemplary implementation of the context derivation component can include using the Hippocratic Database Driver (HDB) driver, which is wrapper around a JDBC driver. The following steps can be performed to derive the context using the HDB Driver. To execute a query, the application needs a connection. It can first get a connection from the database using the HDB Driver, by passing a JDBC database uniform resource locator (URL) to the HDB driver.

The JDBC database URL can be of the format JDBC:SubProtocol where subprotocol varies from database vendor to vendor. For example, the JDBC URL for DB2 can have formal JDBC:DB2://<Machine_ip:database_port>/<DatabaseName> and the URL for Oracle can be of the form: JDBC:ORACLE:thin:@//<MachineIP:server port(>.

Generally, a JDBC URL is configurable and stored outside the application in a configuration file for ease of modification and security reasons. In FIG. 3, an application passes user name and application ID to the context derivation component. To pass the application ID, the HDB driver supports modified database URL, which is of format JDBC:<database_url>#applicationID#, where # is a delimiter. Using this type of URL, the application ID can be passed to the driver, which internally parses the application ID and retrieves the appropriate context.

Also, application context information can be stored in a table referred to, for example, as the application usage table. This table can have the following format:

| | | |
|---|---|---|
| ApplicationID | Purpose | Accessor |

Once the HDB connection is returned to application, it gets a Java statement object from the connection and uses this statement object to execute the query. Along with the query, meta info is also passed to the context derivation component. To associate privacy semantics with the structured query language (SQL) query, the context derivation component retrieves the purpose from application usage table using application ID and accessor. For this scenario, accessor and purpose are collectively referred to as privacy semantics. SQL query with privacy semantics can be passed to a query interface class, which constructs the XML query graph model (XQGM) representation of query. This representation, along with privacy semantics., can be passed to a query rewriter, which extracts the applicable privacy rules from the disclosure metadata store and rewrites the query, which now contains privacy enforcement constructs. This rewritten SQL query can be given to the query interface again, which executes it and returns the result to application.

As described herein, one or more embodiments of the invention include automatically deriving the context based on the meta-information provided by the application, as well as automatically deriving the context without any manual intervention of a user. A user can issue SQL query to access the data, and context can be derived automatically and the query modified based on the context. The techniques described herein also include a context derivation component that is independent of a database, so it can be used with any database. Also, because it is independent of a database, the component does not require any programming or database specific knowledge.

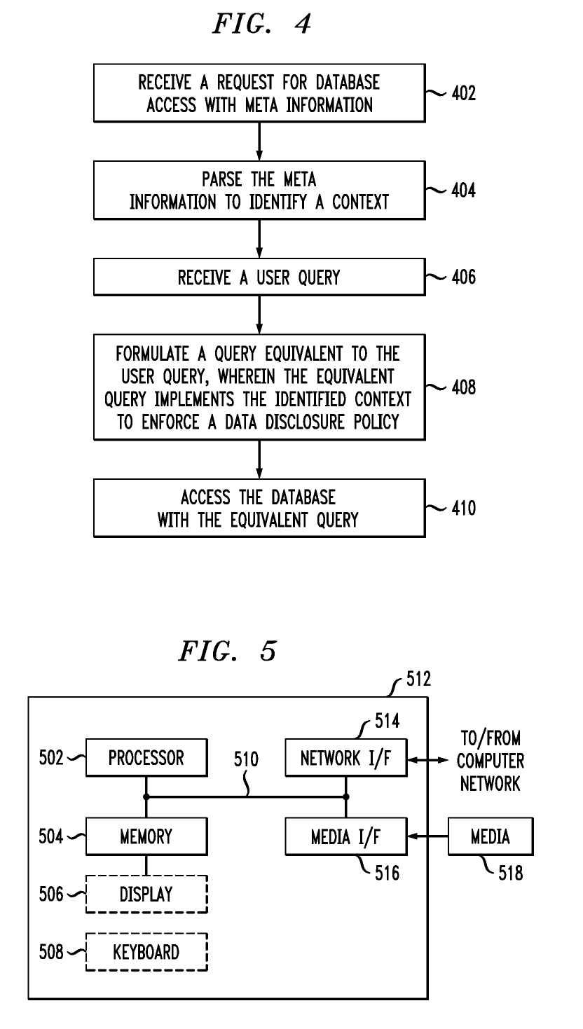

FIG. 4 is a flow diagram illustrating techniques for deriving a context for enforcing a data disclosure policy while accessing a database, according to an embodiment of the present invention. Step 402 includes receiving a request for database access with meta information. Meta information can include, for example, application environment information. Step 404 includes parsing the meta information to identify a context. Identifying the context can be performed independent of a database. Step 406 includes receiving a user query.

Step 408 includes formulating a query equivalent to the user query, wherein the equivalent query implements the identified context to enforce a data disclosure policy. Formulating a query equivalent to the user query can include passing context information to a disclosure control system automatically without user intervention, modifying the request, executing the request and returning at least one result to an application. Formulating a query equivalent to the user query can also include, for example, using the context to retrieve relevant privacy policy rules, modifying the request, executing the request and returning one or more results to an application. Step 410 includes accessing the database with the equivalent query.

The techniques depicted in FIG. 4 can also include parsing the meta information and using it to derive the context from a context repository. Additionally, disclosure controls can be placed at a data source and/or an interface level. As noted herein, rules to a particular request can be determined, for example, by evaluating the context, wherein context includes parameters that embody information about an application environment of the request.

A variety of techniques, utilizing dedicated hardware, general purpose processors, software, or a combination of the foregoing may be employed to implement the present invention. At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

At present, it is believed that the preferred implementation will make substantial use of software running on a general-purpose computer or workstation. With reference to FIG. 5, such an implementation might employ, for example, a processor 502, a memory 504, and an input and/or output interface formed, for example, by a display 506 and a keyboard 508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a Hash memory and the like. In addition, the phrase “input and/or output interface” as used herein, is intended to include, for example, one or more mechanisms for inputting data to the processing unit (for example, mouse), and one or more mechanisms for providing results associated with the processing unit (for example, printer). The processor 502, memory 504, and input and/or output interface such as display 506 and keyboard 508 can be interconnected, for example, via bus 510 as part of a data processing unit 512. Suitable interconnections, for example via bus 510, can also be provided to a network interface 514. such as a network card, which can be provided to interface with a computer network, and to a media interface 516, such as a diskette or CD-ROM drive, which can be provided to interface with media 518.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 518) providing program code for use by or in connection with a computer or any instruction execution system. For the purposes of this description, a computer usable or computer readable medium can be any apparatus for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory (for example, memory 504), magnetic tape, a removable computer diskette (for example, media 518), a random access memory (RAM), a read-only memory (ROM), a rigid magnetic disk and an optical disk. Current examples of optical disks include compact disk-read only memory (CD-ROM), compact disk-read and/or write (CD-R/W) and DVD.

A data processing system suitable for storing and/or executing program code will include at least one processor 502 coupled directly or indirectly to memory elements 504 through a system bus 510. The memory elements can include local memory employed during actual execution of the program code, bulk storage, and cache memories which provide temporary storage of at least some program code in order to reduce the number of times code must be retrieved from bulk storage during execution.

Input and/or output or I/O devices (including but not limited to keyboards 508, displays 506, pointing devices, and the like) can be coupled to the system either directly (such as via bus 510) or through intervening I/O controllers (omitted for clarity).

Network adapters such as network interface 514 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

At least one embodiment of the invention may provide one or more beneficial effects, such as, for example, automatically deriving the context without any manual intervention of a user.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for deriving a context for enforcing a data disclosure policy while accessing a database, comprising the seeps of:
receiving a request for database access with meta information;
parsing the meta information to identify a context;
receiving a user query;
formulating a query equivalent to the user query, wherein the equivalent query implements the identified context to enforce a data disclosure policy; and
accessing the database with the equivalent query.

2. The method of claim 1, further comprising parsing the meta information and using it to derive the context from a context repository.

3. The method of claim 1, further comprising placing a disclosure control at at least one of a data source and an interface level.

4. The method of claim 1, further comprising determining one or more rules to a particular request by evaluating the context, wherein context comprises one or more parameters that embody information about an application environment of the request.

5. The method of claim 1, wherein formulating a query equivalent to the user query comprises passing context information to a disclosure control system automatically without user intervention, modifying the request, executing the request and returning at least one result to an application.

6. The method of claim 1, wherein the meta information comprises application environment information.

7. The method of claim 1, wherein formulating a query equivalent to the user query comprises using the context to retrieve one or more relevant privacy policy rules, modifying the request, executing the request and returning one or more results to an application.

8. The method of claim 1, wherein identifying the context is performed independent of a database.

9. A computer program product comprising a computer readable medium having computer readable program code for deriving a context for enforcing a data disclosure policy while accessing a database, said computer program product including:
computer readable program code for receiving a request for database access with meta information;
computer readable program code for parsing the meta information to identify a context;
computer readable program code for receiving a user query;
computer readable program code for formulating a query equivalent to the user query, wherein the equivalent query implements the identified context to enforce a data disclosure policy; and
computer readable program code for accessing the database with the equivalent query.

10. The computer program product of claim 9, further comprising computer readable program code for parsing the meta information and using it to derive the context from a context repository.

11. The computer program product of claim 9, further comprising computer readable program code for determining one or more rules to a particular request by evaluating the context, wherein context comprises one or more parameters that embody information about an application environment of the request.

12. The computer program product of claim 9, wherein the computer readable code for formulating a query equivalent to the user query comprises computer readable program code for passing context information to a disclosure control system automatically without user intervention, modifying the request, executing the request and returning at least one result to an application.

13. The computer program product of claim 9, wherein the computer readable code for formulating a query equivalent to the user query comprises computer readable program code for using the context to retrieve one or more relevant privacy policy rules, modifying the request, executing the request and returning one or more results to an application.

14. The computer program product of claim 9, wherein the computer readable code for identifying the context comprises computer readable program code for identifying the context independent of a database.

15. A system for deriving a context for enforcing a data disclosure policy while accessing a database, comprising:
a memory; and
at least one processor coupled to said memory and operative to:
receive a request for database access with meta information;
parse the meta information to identify a context;
receive a user query;
formulate a query equivalent to the user query, wherein the equivalent query implements the identified context to enforce a data disclosure policy; and
access the database with the equivalent query.

16. The system of claim 15, wherein the at least one processor coupled to said memory is further operative to parse the meta information and using it to derive the context from a context repository.

17. The system of claim 15, wherein the at least one processor coupled to said memory is further operative to determine one or more rules to a particular request by evaluating the context, wherein context comprises one or more parameters that embody information about an application environment of the request.

18. The system of claim 15, wherein in formulating a query equivalent to the user query, the at least one processor coupled to said memory is further operative to pass context information to a disclosure control system automatically without user intervention, modifying the request, executing the request and returning at least one result to an application.

19. The system of claim 15, wherein in formulating a query equivalent to the user query, the at least one processor coupled to said memory is further operative to use the context to retrieve one or more relevant privacy policy rules, modifying the request, executing the request and returning one or more results to an application.

20. The system of claim 15, wherein in identifying the context, the at least one processor coupled to said memory is further operative to identify the context independent of a database.
